(19) United States
(12) Patent Application Publication
(10) Pub. No.: US 2012/0227096 A1
(43) Pub. Date: Sep. 6, 2012

(54) METHOD AND APPARATUS FOR TRANSFERRING DATA

(75) Inventor: Christopher Paul Edwards, Lutterworth (GB)

(73) Assignee: Intercede Limited, Lutterworth (GB)

(21) Appl. No.: 13/407,057

(22) Filed: Feb. 28, 2012

(30) Foreign Application Priority Data
Mar. 4, 2011 (GB) 1103737.1

(51) Int. Cl. H04L 9/32; G06F 21/00

(52) U.S. Cl. 726/7

(57) ABSTRACT

A method and apparatus for transferring data to a mobile device is described. Authentication information associated with a user is received and used to authenticate the user. A one-time-use password is determined and an identity of a mobile device and/or a mobile device operator is verified. Encrypted data is transmitted to the mobile device, where the encryption is based, at least in part, on the one-time-use password. On receipt of the password at the mobile device, the data may be decrypted for use by the mobile device.

### RELATED APPLICATION

This application claims the benefit of GB patent application number 1103737.1, filed on 04 Mar. 2011, the disclosure of which is incorporated herein by reference in its entirety.

### BACKGROUND

It is often desired to transfer data to mobile devices, such as telephones, personal digital assistants etc. However, securely transferring data to such devices can be problematic.

The embodiments described below are not limited to implementations which solve any or all of the disadvantages of known methods and systems for transferring data.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

A method and apparatus for transferring data to a mobile device is described. In an embodiment, authentication information associated with a user is received and used to authenticate the user. A one-time-use password is determined and an identity of a mobile device and/or a mobile device operator is verified. Encrypted data is transmitted to the mobile device, where the encryption is based, at least in part, on the one-time-use password.

On receipt of the password at the mobile device, the data may be decrypted for use by the mobile device.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 shows a schematic diagram of an example system 100 for transferring data;

FIG. 2 shows an example method of transferring data;

FIG. 3 shows example communication flows;

FIG. 4 shows an example data packet;

FIG. 5 shows a further example method of transferring data; and

FIG. 6 shows an exemplary computing-based device.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

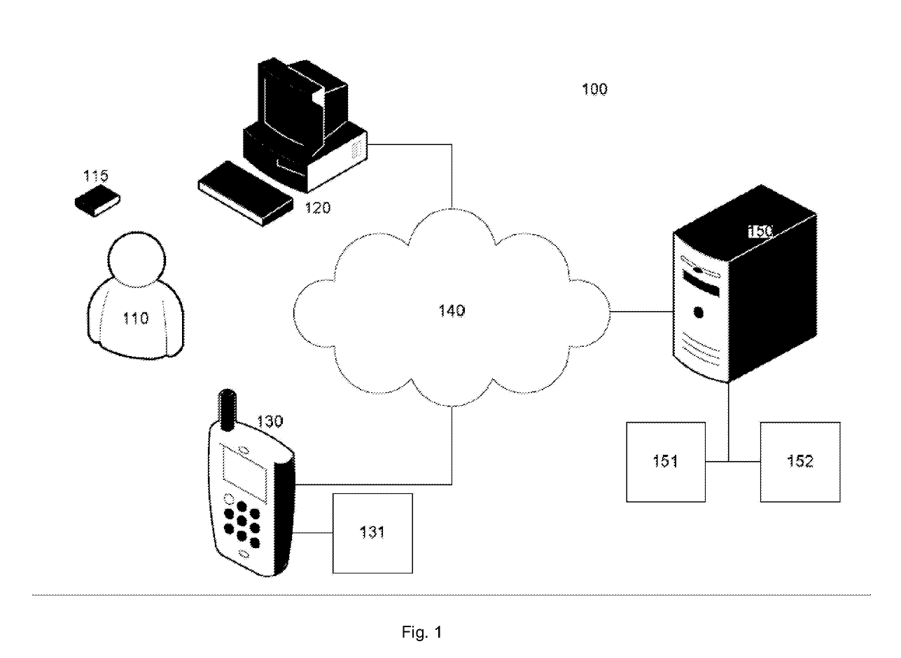

FIG. 1 illustrates a system 100 for transferring data. The system 100 comprises a user 110, a client computer 120, a mobile device 130, one or more communication networks 140 and a server computer 150.

The user 110 may be a possessor of the mobile device 130 i.e. a person to whom the mobile device belongs or is assigned. However, the various embodiments described herein are not limited in this respect. The user 110 may be, for example, an administrator of the mobile device 130, such as a person responsible within an organisation for ensuring that the mobile device 130 has any necessary data stored thereon for use by one or more other persons. In some embodiments, information associated with the user is stored in a user profile 151 accessible to the server 150, as will be explained.

In some embodiments, the user 110 is in possession or is associated with a smart card or token 115. The smart card 115 is used in some embodiments to enable authentication of the user 110 to the server 150.

The client computer 120 is a computer via which the user 110 authenticates with the server 150. In some embodiments, however, the client computer 120 and server 150 are the same machine. That is, the user 110 may directly access the server 150, without the client computer 120, to transfer data to the mobile device 130. As noted above, the authentication may involve presentation of the smart card 115 to the client computer 120, in some embodiments, such as by being received in a communication port or reader of the client computer 120. However, in other embodiments the client computer 120 may receive one or more items of authentication information from the user 110, such as via data entry to a keyboard of the client computer 120. The authentication may alternatively or additionally involve the client computer 120 receiving information indicating one or more biometric characteristics of the user, such as fingerprint, iris recognition, etc.

Although the client computer 120 is shown in FIG. 1 as a desktop computer, it will be understood that this is by way of example only and is not a limitation. The client computer 120 may be any type of device which allows an identity of the user to be verified by the server 150. In some embodiments, the client computer 120 has a separate communication path to the server 150 than the mobile device 130 i.e. the client computer 120 and the mobile device 130 communicate data with the server 150 via paths which are at least partly separate. The client computer 120 may be, for example, a computer kiosk which the user 110 accesses to request data be transferred to the mobile device 130. In embodiments wherein the user 110 utilizes the smart card 115, the client computer 120 includes an interface arranged to facilitate communication between the smart card 115 and the client computer 120. The interface may be contact-based, for example it may comprise physical contacts for engaging with terminals of the smart card 115, or the interface may be contactless, such as utilising induction based communication techniques.

The mobile device 130 may be any type of mobile device. In particular, although not exclusively, the mobile device 130 may be any of a mobile telephone, a smart phone, personal digital assistant, tablet computer, or the like. In some embodiments, the mobile device 130 includes a software module or component 131. The software module 131 may be a Java applet which is stored on the mobile device 130 prior to executing a method according to an embodiment described herein. For example, the software module 131 may be downloaded to the mobile device 130 from the server 150 or from another source, such as an application store or other repository of applications.

In FIG. 1, the communication network 140 is shown as being a single entity, such as the Internet. However, it is envisaged that in some embodiments, the communications network will comprise a plurality of communication networks. For example, it is envisaged that the client computer 120 will communicate data with the server computer via one or more computer networks, such as over an IP protocol, whilst the mobile device 130 will communicate data with the server 150, at least partly, over a mobile communication network, such as GPRS, GSM, 3G standards such as UMTS, 30 4G standards such as LTE-Advanced, mobile WiMAX (IEEE 802.16e-2005) or the like.

The server computer 150 may be any type of computer system capable of implementing a method of transferring data as described herein. Although the server 150 is shown in FIG. 1 as a single computer, this is merely for illustration and the server computer 150 may comprise a plurality of computer systems and/or a computer system having multiple processors etc. The server 150 is communicatively coupled to the client computer 120 and mobile device 130 to authenticate the user 110 via the client computer 120 and the mobile device 130, and then send data to the mobile device 130 for storage in a location which is accessible to the mobile device 130, as will be explained. In some embodiments, the server 150 has access to one or more stores 151, 152. In some embodiments, the store may store user information 151 associated with one or more users of the system 100. In some embodiments the user information 151 comprises one or more user records including a user record associated with the user 110 of the system. The user records 151 may store identification information of each user, such as name and contact details. The user information 151 may also include, in some embodiments, mobile device 130 identification information (MDID). The MDID may be any information which uniquely identifies the mobile device 130, such as a telephone number or IP address of the mobile device 130. The store may also hold data 152 which is to be securely communicated to the mobile device.

In various embodiments utilising the smart card 115, the smart card 115 is a device for authenticating the user 110. The smart card 115 or integrated circuit card may be a device issued to the user 110 which comprises a memory portion and a logic portion (not shown for clarity). The memory portion may comprise one or more items of data which enable the server 150 to verify the identity of the user 110, such as encryption keys and/or certificates. The logic may be logic for enabling a device, such as the client computer 120, to decrypt received data using the encryption key(s) stored in the memory portion.

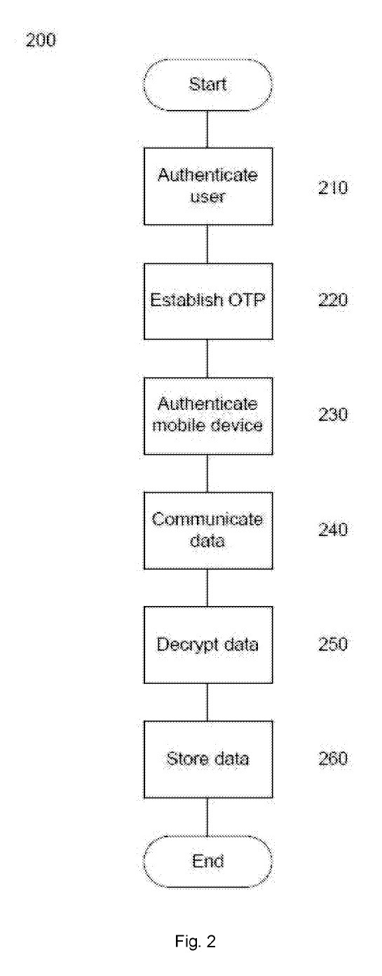

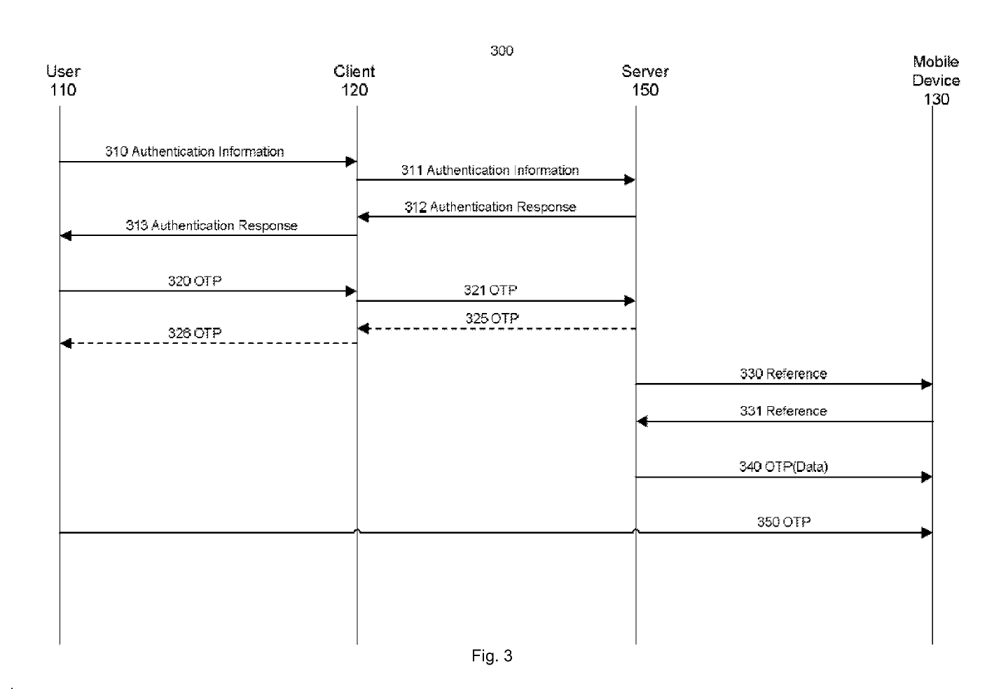

A method of transferring data will now be described with reference to FIGS. 2 and 3 in particular.

FIG. 2 illustrates an example method 200 of transferring data. As shown in FIG. 2, a step 210 comprises authenticating the user 110. As discussed above, the user 110 may be authenticated to the server 150 in a variety of ways. In one embodiment, the user 110 is authenticated by multi-factor authentication using the smart card 115. The multi-factor authentication may be two-factor authentication involving use of the smart card and authentication information such as a password or PIN. Alternatively, bioinformatics may be used as a factor of the authentication process.

FIG. 3 illustrates authentication information, such as the PIN and smart card, being provided 310 from the user 110 to the client 120. The PIN may be used to authenticate to the smart card to generate authentication information which is then sent from 311 the client computer 120 to the server 150. However, it will be realized that step 210 may also involve communication of data from the server 150 to the client computer 120 and from the client computer 120 to the user 110. For example, in some embodiments, the server 150 may provide a logon screen, such as a secure web page, which requests a user to enter a logon ID and password i.e. such embodiments may not require the smart card 115. In response, the user enters their user ID and password into the client computer 120 which communicates this data to the server 150, thus step 210 may involve bi-directional communication which is not specifically illustrated in FIG. 2. Following receipt of the authentication information 311 by the server 150, the server communicates an authentication response 312 to the client computer. The authentication response indicates whether the authentication information has been verified by the server 150. In response, the client computer 120 may output 313 an authentication response 313 to the user 110, such as indicating on a display of the client computer 120 that the authentication has been successful.

Step 220 comprises establishing a one-time password (OTP) between the user 110 and server 150. In some embodiments, the OTP may be established by the client computer 120 outputting a request for the OTP to the user 110 and receiving 320 the OTP from the user 110, which is then transmitted 321 to the server 150 from the client computer 120. In some embodiments, although not necessarily, the server 150 may verify that the OTP is unique i.e. has not been used previously by the user 110.

In other embodiments indicated with dashed lines in FIG. 3, the server 150 may generate the OTP which is then communicated 325 to the client computer 120 and output 326, for example on a display, to the user 110. The OTP may be communicated to the client computer 120 in a variety of way, such as part of a web page forming the authentication process which is displayed to the user. In still further embodiments, the OTP may be generated by the server 150 and communicated to the user via other means, such as by email, by post in printed form or to their mobile device 130 such as in a text, SMS message or using another notification service. Therefore it will be realized that steps 210 and 220 shown in FIG. 2 may take place in any order.

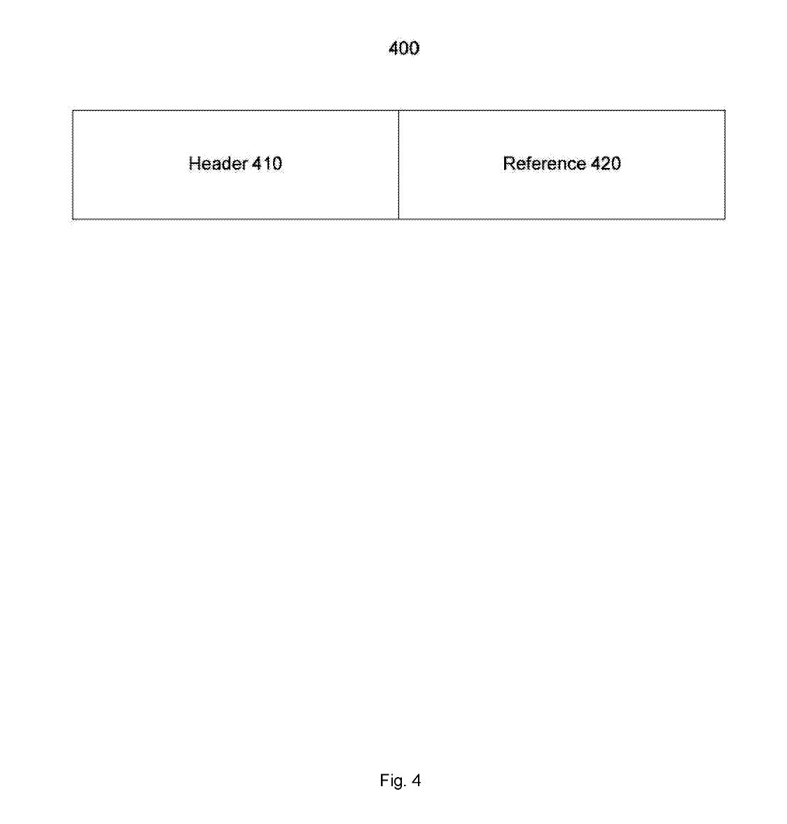

In step 230 the mobile device is authenticated. In some embodiments, the operator of the mobile device may alternatively or additionally be authenticated. The mobile device is authenticated to confirm the identity of the mobile device 130. As part of step 150, the server 150 generates a reference for the data transfer. In some embodiments, the reference is unique or substantially unique i.e. will not be reused for a considerable period of time. The reference is then communicated 330 to the mobile device 130, as shown in FIG. 3. The reference may be communicated to the mobile device in a variety of ways. In some embodiments, the reference is communicated to the mobile device in a text or SMS message to the telephone number of the mobile device which is retrieved from the user profile associated with the user 110 authenticated in step 210. In other embodiments, the reference may be communicated 330 to the mobile device 130 in an email, using an alternative notification service, or via another communication protocol. The reference may be communicated to the mobile device 130 as a data packet 400, as shown in FIG. 4. The data packet 400 includes a header portion 410 and a data portion 420 comprising the reference generated by the server 150. The header portion 410 may be used to automatically activate an authentication module or software component on the mobile device 130, as explained below. The user of the mobile device 130 may be asked to enter a value, such as a password known to the server, which is also sent to the server 150 to verify the identity of the user of the mobile device 130.

In response to receiving the reference 420 at the mobile device 130, the authentication module or software component 131, such as a Java applet, (herein all referred to as remote agent 131) may be executed. The remote agent 131 may be executed on the mobile device 130 in response to a user input at the mobile device 130 i.e. the user may manually activate the remote agent 131, such as by activating a menu option or graphical icon on a user interface of the mobile device 130, or the remote agent 131 may be automatically activated in response to the mobile device 130 detecting the received header 410 of a predetermined format.

Once activated, the remote agent 131 on the mobile device 130 establishes communication with the server 150. The remote agent 131 may establish communication with a counterpart piece of authentication software executing on the server 150. The remote agent 131 5 may communicate with the server 150 over http or https, for example. The remote agent 131 is arranged to communicate 331, in some form, the reference 420 to the server 150. The reference 420 may be communicated to the server 150 in the form that it was received by the mobile device 130, with or without the header 410. In one embodiment, the remote agent 131 on the mobile device 130 is arranged to compute a hash value of the reference 420. The hash value is then communicated to the server 150, thereby enabling the server 150 to verify that the reference 420 was received by a device having an appropriate hash function. Furthermore, in some embodiments, the reference 420 may be combined with information derived from the mobile device 130 or remote agent 131 to further improve security. In one embodiment, the hash value is computed based on the received reference 420 and identification information of the remote agent 131, such as an ID or serial number thereof, thereby enabling the server 150 to verify the ID of the remote agent 131 and the reference 420.

In step 240, the server 150 communicates 340 encrypted data to the mobile device 130. The data is encrypted, at least in part, based on the OTP established in step 220.

In some embodiments, the data may also be encrypted based on other information, such as a username of the user 110 etc. In response to receiving the encrypted data, the remote agent 131 executing on the mobile device 130 requests that the user 110 enters 350 the OTP into the mobile device 130. For example, the remote agent 131 may cause a message to be displayed on a display of the mobile device 130 requesting that the user 110 enters 350 the OTP via a keypad of the mobile device 130. The user may also be requested to enter any further information required to decrypt the received data. The received OTP is then used to decrypt the received data in step 250. In some embodiments, the OTP may be entered 350 into the mobile device 130 prior to the encrypted data being received. In these embodiments, the mobile device 130 may communicate the OTP, or a value derived there from, to the server 150 in order to initiate the communication 340 of the encrypted data to the mobile device 130.

Once decrypted, the data is stored in a storage location or memory accessible to the mobile device 130. The data may be stored within a volatile or non-volatile memory accessible to the mobile device 130. The memory may be located within the mobile device 130, such as a built-in memory, or the memory may be a removable or external memory device, such as a memory card or external storage device. In some embodiments, the memory is located on a Subscriber Identity Module (SIM) card of the mobile device 130, or on another removable memory device, such as a micro-SD or a cryptographically protected memory card. In further embodiments, the data may be stored in another device which is, or may be periodically, communicably connected to the mobile device 130. Such devices may be those having a data storage portion, such as cameras, navigation devices etc. Such devices may communicate with the mobile device 130 at least periodically over a wired or wireless connection, such as Bluetooth or Wi-Fi, although these are merely exemplary. In some embodiments, the data may be stored in encrypted form and only decrypted using the OTP when required.

As a result of the method 200, data is securely transferred from the server 150 to the mobile device 130 and is stored in a location accessible to the mobile device 130 for later use by the mobile device 130.

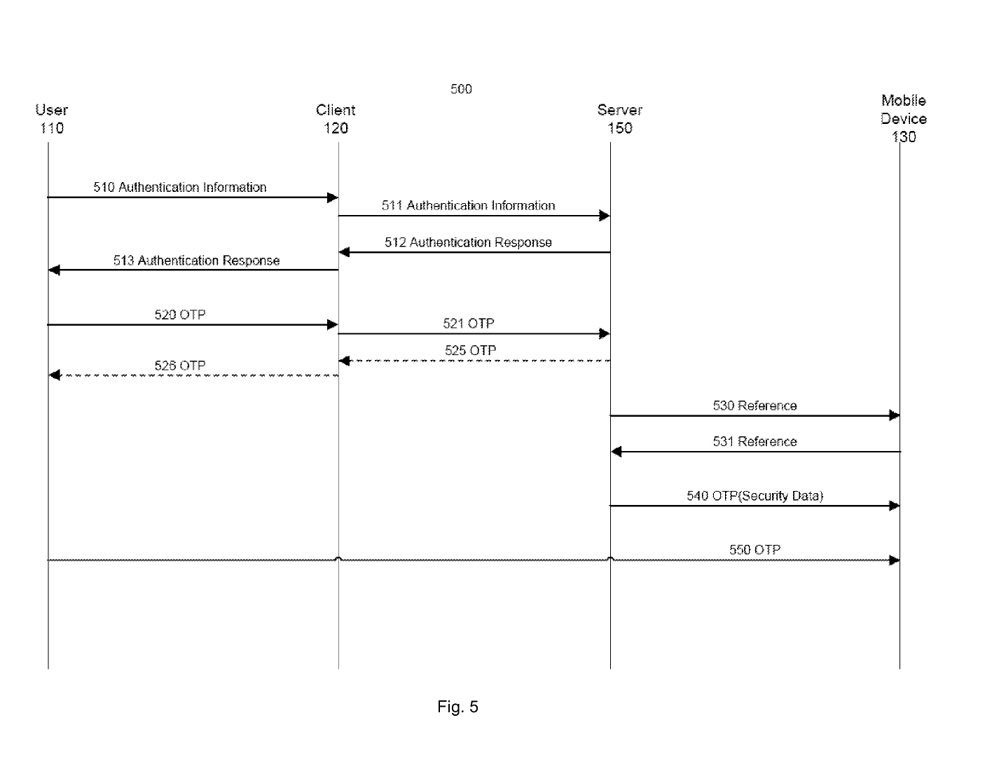

Further embodiments will now be described with reference to FIG. 5.

In order to improve security in computer systems, especially distributed computer systems where a client computer or device communicates with a remotely located server computer, users are often provided with a smart card or integrated chip card (ICC). A smart card typically comprises a memory storage component and logic. Frequently the memory storage component is used to hold one or more keys and/or certificates. The one or more keys may be public or private keys and the certificates may enable an identity of a person to be verified, as is known in the art. The smart card may be used in authenticating a holder to the computer system by inserting the smart card into a card reader communicatively coupled to the computer system. Once inserted into the card reader, the smart card may, for example, provide a decryption service for the computer system using the stored key and logic on the smart card. The stored keys may be used to decrypt received data, such as encrypted data received at the client computer from the server computer. The received data may be communication data, such as emails or other forms of communication data.

Often, users wish to utilize a smart card with a computing device, such as to access encrypted data with the device. For example, users may wish to read encrypted emails on the device. However, it is sometimes difficult or inconvenient for the device to access the smart card to utilize keys and/or certificates stored thereon to encrypt/decrypt data or to digitally sign data. One prior solution to this is the use of an external smart card reader. The external smart card reader connects to the device to provide an interface to the smart card. The smart card reader may connect to the device via a wired interface, such as via a USB connection, or via a wireless interface, such as Bluetooth. Some of the embodiments described herein reduce the problems associated with using security data, such as keys and/or certificates, with mobile computing devices, such as portable computers, tablet computers, mobile phones, personal digital assistants, smart phones etc.

An embodiment will now be described with reference to FIG. 5 for transferring security data, such as keys and/or certificates, to a mobile device. The embodiment described with reference to FIG. 5 may be used to transfer a copy of security data, such as one or more keys and/or certificates, stored on a smart card to a storage location accessible by the mobile device, thereby enabling the mobile device to perform security operations, such as encrypting/decrypting data, without requiring the mobile device to communicate with the smart card.

This embodiment is similar in operation to that previously described with reference to FIGS. 1-4 so, unless otherwise stated, the details provided above with respect to those

Figures apply to the embodiment of FIG. 5. FIG. 5 shows a method 500 which may be implemented in a system 100 comprising a user 110, a client computer 120, a mobile device 130, one or more communication networks 140 and a server computer 150, as previously discussed with reference to FIG. 1.

In step 510, the user 110 provides authentication information to the client computer 5 120. The authentication information may be, as previously described, a PIN and the smart card 115 being provided 310 from the user 110 to the client computer 120. The PIN may be utilized with the smart card 115 to generate authentication information which is sent from 511 the client computer 120 to the server 150. However in other embodiments, the user may enter a user ID and password into the client computer 120 which communicates 511 this data to the server 150 i.e. the authentication of the user 110 to the server may not involve the smart card 115. The user 110 may also provide the authentication information directly to the server computer, for example by inserting the smart card into a reader associated with the server 150, or by inputting information directly into the server 150, for example using a keyboard of the server computer.

Once having determined the authentication of the user, the server 150 communicates an authentication response 512 to the user via, in some embodiments, the client computer 120. The authentication response indicates whether the authentication information has been authenticated by the server 150. In response, the client computer 120 may output an authentication response 513 to the user 110, such as indicating on a display of the client computer 120 that the authentication has been successful.

A one-time password (OTP) is established between the user 110 and server 150. As discussed above, in some embodiments, the OTP may be established by the client computer 120 outputting a request for the OTP to the user 110 and receiving 520 the OTP from the user 110, which is then transmitted 521 to the server 150 from the client computer 120. However, in other embodiments indicated with dashed lines in FIG. 5, the server 150 may generate the OTP which is then communicated 525 to the client computer 120 and output 526, for example on a display, to the user 110. In still further embodiments, the OTP may be generated by the server 150 and communicated to the user via other means, such as by email, by post in printed form or to their mobile device 130 such as in a text or SMS message or using another notification service. In these embodiments, the OTP is not necessarily communicated via the client computer 120.

The mobile device 130 is authenticated to confirm the identity of the mobile device 130. The server 150 generates a reference which, in some embodiments, is unique or substantially unique i.e. will not be reused for a considerable period of time. The reference is communicated 530 to the mobile device 130. The reference may be communicated to the mobile device 130 in a text or SMS message to the telephone number of the mobile device 130 which is retrieved from the user profile associated with the user 110. In other embodiments, the reference may be communicated 530 to the mobile device 130 in an email, or via another communication method or protocol (e.g. using an alternative notification service).

The reference may be communicated to the mobile device 130 as a data packet 400, as shown in and previously discussed with reference to FIG. 4. The data packet 400 may include the header portion 410 and the data portion 420 comprising the reference. In response to receiving the reference 420 at the mobile device 130, the remote agent 131 may be executed on the mobile device 130. The remote agent 131 may be manually or automatically activated on the mobile device 130. Once activated, the remote agent 131 establishes communication with the server 150 and is arranged to communicate 331, in some form, the reference 420 back to the server 150. The reference 420 may be communicated to the server 150 in the form that it was received or in a modified form, such as a hash value of the reference 420. In some embodiments, the reference 420 may be combined with information derived from the mobile device 130 or remote agent 131 to further improve security, as discussed above.

The server 150 communicates 540 encrypted security data, such as one or more keys and/or certificates, to the mobile device 130. The security data is encrypted, at least in part, based on the OTP. In some embodiments, the data may also be encrypted based on other information, such as a username of the user 110 etc. In response to receiving the encrypted data, the remote agent 131 executing on the mobile device 130 requests that the user 110 enters 550 the OTP into the mobile device 130. For example, the remote agent 131 may cause a message to be displayed on a display of the mobile device 130 requesting that the user 110 enters 550 the OTP via a keypad of the mobile device 130. The user may also be requested to enter any further information required to decrypt the received data. The received OTP is then used to decrypt the received security data.

Once decrypted, the security data is stored in a storage location or memory accessible to the mobile device 130, such as within a volatile or non-volatile memory accessible to the mobile device 130. The memory may be located within the mobile device 130, such as a built-in memory, or the memory may be a removable or external memory device, such as a memory card or external storage device. In some embodiments, the memory is located on a Subscriber Identity Module (SIM) card of the mobile device 130, or on another removable memory device, such as a micro-SD or a cryptographically protected memory card.

The security data may then be used by the mobile device 130 to perform security operations. For example, in cases where the security data comprises one or more keys (public or private keys) they may be used to encrypt and/or decrypt data. The data may be data received by and/or sent by the mobile device 130, such as communication data i.e. emails. The security data may also be used to digitally sign data in the cases that the security data comprises one or more digital certificates.

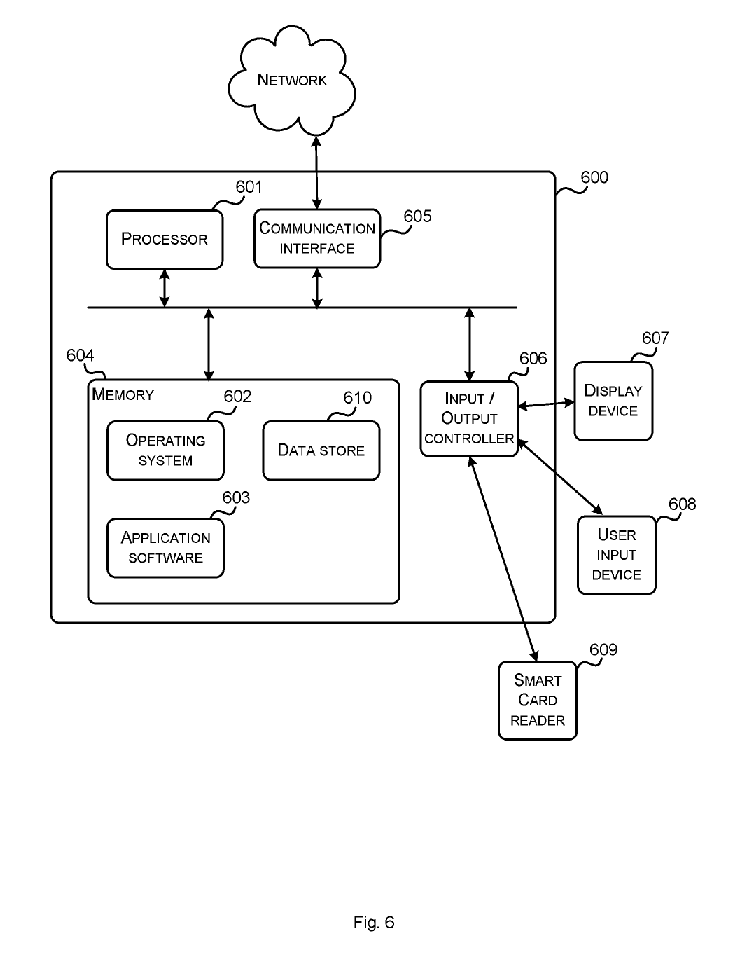

FIG. 6 illustrates various components of an exemplary computing-based device 600 which may be implemented as any form of a computing and/or electronic device, and in which embodiments of the methods of transferring data described herein may be implemented. For example, any of the client computer 120, mobile device 130 and server computer 150 may be provided by computing-based devices in accordance with, or similar or related to, the exemplary device 600.

Computing-based device 600 comprises one or more processors 601 which may be microprocessors, controllers or any other suitable type of processors for processing computer executable instructions to control the operation of the device in order to implement aspects or all of one or more of the various embodiments described herein. In some examples, for example where a system on a chip architecture is used, the processors 601 may include one or more fixed function blocks (also referred to as accelerators) which implement a part of the method of transferring data in hardware (rather than software or firmware). Platform software comprising an operating system 602 or any other suitable platform software may be provided at the computing-based device to enable application software 603 to be executed on the device. The application software 603 may comprise software module 131, as described above, where the computing-based device 600 is a mobile device. Where the computing-based device 600 is a server, the application software 603 may comprise an authentication module arranged to authenticate the user and/or a verification module arranged to verify the identity of a mobile device and/or mobile operator.

The computer executable instructions may be provided using any computer-readable media that is accessible by computing based device 600. Computer-readable media may include, for example, computer storage media such as memory 604 and communications media. Computer storage media, such as memory 604, includes volatile and non-volatile, removable and non-removable media implemented in any method or technology for storage of information such as computer readable instructions, data structures, program modules or other data. Computer storage media includes, but is not limited to, RAM, ROM, EPROM,

EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Although the computer storage media (memory 604) is shown within the computing-based device 600 it will be appreciated that the storage may be distributed or located remotely and accessed via a network or other communication link (e.g. using communication interface 605). Memory 604 may also provide one or more data stores 610 (e.g. data stores 151 as described above, where computing-based device 600 is a server).

The communication interface 605 may be arranged to enable communication between the computing-based device 600 and other computing-based devices. For example, where the device 600 is a server, the communication interface 605 may be used to communicate with a mobile device via the network and where the device 600 is a mobile device, the communication interface 605 may be used to communicate with a server via the network.

The computing-based device 600 also comprises an input/output controller 606 arranged to output display information to a display device 607 which may be separate from or integral to the computing-based device 600. The display information may provide a graphical user interface. The input/output controller 606 is also arranged to receive and process input from one or more devices, such as a user input device 608 (e.g. a mouse, keyboard, camera, microphone or other sensor). In some examples the user input device 608 may detect voice input, user gestures or other user actions and may provide a natural user interface. This user input may be used to input the OTP or other information or data for use in the embodiments of transferring data. In an embodiment the display device 607 may also act as the user input device 608 if it is a touch sensitive display device. The input/output controller 606 may also output data to devices other than the display device, e.g. a locally connected printing device (not shown in FIG. 6).

The input/output control 606 may also be arranged to receive and output data from/to other devices, either internal or external to the computing-based device 600, for example smart-card reader 609.

Further aspects are set out in the following paragraphs:

An example comprises a method of transferring data to a mobile device, the method comprising: receiving authentication information associated with a user and authenticating the user based on the authentication information; determining a one-time use password; verifying an identity of a mobile device and/or a mobile device operator; transmitting encrypted data to the mobile device, the encryption based, at least in part, on the password; and receiving, at the mobile device, the password and decrypting the data for use by the mobile device.

The authentication information may be determined, at least in part, based on an encryption key. The encryption key may be stored in a smart card. The authentication information may be received from a client computer. The authentication information may be determined based, at least in part, on information received from a user.

The password may be received from a user or the password may be generated and output to the user. The password may be output on a display device (e.g. a display device of a client computer), as a printed document, or in an electronic message. The method may further comprise receiving the password at a server computer.

The identity of the mobile device may be verified by sending a message to the mobile device. This message may comprise a reference value (which may be generated by a server) and the method may further comprise receiving a response message from the mobile device based at least partly on the response value. In an example, the response message contains the reference value or a value determined according to the reference value. The message may be sent to the mobile device based on mobile device identification information associated with a user profile. In an example, the message is a short message service (SMS) message or an email.

The method may further comprise storing the data in a storage location accessible to the mobile device and in some examples, the data may be security data and in such an example, the security data may comprise one or more keys and/or certificates. These one or more keys may be used to decrypt or encrypt communication data received by the mobile device.

Another example comprises a server for sending data to a mobile device, wherein the server is arranged to: receive authentication data associated with a user and to authenticate the user based on the authentication data; determine a one-time-use password; verify an identity of a mobile device and/or mobile device operator; transmit encrypted data to the mobile device, the data being encrypted based, at least in part, on the password.

The authentication information may be at least partly received from a user. The authentication information may be received from a client computer. The authentication information may be determined, at least in part, based on an encryption key.

The one time use password may be determined by the server and output to a user. The server may be arranged to output the password on a display device or to communicate the password to another device for outputting the password to the user.

The server may be arranged to verify the identity of the mobile device by sending a message to the mobile device. The server may be arranged to generate a reference value and to include the reference value in the message. The server may be arranged to receive a response message from the mobile device and to compare a value derived from the response message against the generated reference value.

The server may be arranged to determine identification information of the mobile device and to send the message to the mobile device based on the identification information. The identification information may be determined from a user profile associated with the user.

The server may be arranged to encrypt the data based, at least in part, on the password. The data may be security data and in such an example, the server may be arranged to obtain the security data based on a user profile associated with the user. The security data may comprise one or more keys and/or certificates.

A further example comprises a computer system, the system comprising a server as described above and a mobile device. The mobile device may, for example, be one of a mobile telephone, a smart phone, a tablet computer or a portable computer.

The system and methods described above may, in some embodiments, be used to securely transfer data, such as security data, to mobile devices.

Computer software may be arranged to perform any of the methods described above when executed on a computer and this computer software may be stored on a computer readable medium.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

It will be appreciated that embodiments described herein can be realized in the form of hardware, software or a combination of hardware and software. Any such software may be stored in the form of tangible (or non-transitory) volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. These examples of tangible (or non-transitory) storage media do not include propagated signals. Propagated signals may be present in tangible storage media, but propagated signals per se are not examples of tangible storage media. It will be appreciated that the storage devices and storage media are embodiments of machine-readable storage that are suitable for storing a program or programs that, when executed, implement embodiments described herein. Accordingly, embodiments provide a program comprising code for implementing a system or method as described herein when the code is run on a computer and tangible machine readable storage storing such a program. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

All of the features disclosed in this specification (including any accompanying claims, abstract and drawings), and/or all of the steps of any method or process so disclosed, may be combined in any combination, except combinations where at least some of such features and/or steps are mutually exclusive. The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

Each feature disclosed in this specification (including any accompanying claims, abstract and drawings), may be replaced by alternative features serving the same, equivalent or similar purpose, or altered or extended unless expressly stated otherwise. Thus, unless expressly stated otherwise, each feature disclosed is one example only of a generic series of equivalent or similar features.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

What is claimed is:

1. A method of transferring data to a mobile device, comprising:
receiving authentication information associated with a user and authenticating the user based on the authentication information;
determining a one-time use password;
verifying an identity of a mobile device and/or a mobile device operator; and
transmitting encrypted data from a server computer to the mobile device, the encryption based, at least in part, on the password.

2. The method of claim 1, wherein the authentication information is received from a client computer.

3. The method of claim 1, comprising receiving the password at the server computer.

4. The method of claim 1, wherein the identity of the mobile device is verified by sending a message to the mobile device.

5. The method of claim 4, wherein the message comprises a reference value and the method comprises receiving a response message from the mobile device based at least partly on the response value.

6. The method of claim 1, wherein the data is security data.

7. The method of claim 1, further comprising: receiving, at the mobile device, the password and decrypting the data for use by the mobile device.

8. A system for sending data to a mobile device, the system comprising a server and wherein the server is arranged to:
receive authentication data associated with a user and to authenticate the user based on the authentication data;
determine a one-time-use password;
verify an identity of a mobile device and/or mobile device operator;
transmit encrypted data to the mobile device, the data being encrypted based, at least in part, on the password.

9. The system of claim 8, wherein the authentication information is at least partly received from a user.

10. The system of claim 9, wherein the authentication information is received from a client computer.

11. The system of claim 8, wherein the server is further arranged to output the one time use password to a user.

12. The system of claim 11, wherein the server is arranged to output the password on a display device or to communicate the password to another device for outputting the password to the user.

13. The system of claim 8, wherein the server is arranged to verify the identity of the mobile device by sending a message to the mobile device.

14. The system of claim 13, wherein the server is arranged to generate a reference value and to include the reference value in the message.

15. The system of claim 8, wherein the server is arranged to encrypt the data based, at least in part, on the password.

16. The system of claim 8, wherein the data is security data.

17. The system of claim 16, wherein the server is arranged to obtain the security data based on a user profile associated with the user.

18. The system of claim 16, wherein the security data comprises one or more keys and/or certificates.

19. The system of claim 8, further comprising a mobile device.

20. One or more tangible device-readable media with device-executable instructions that, when executed by a computing system, direct the computing system to perform steps comprising
receiving authentication information associated with a user and authenticating the user based on the authentication information;
determining a one-time use password;
verifying an identity of a mobile device and/or a mobile device operator; and
transmitting encrypted data to the mobile device, the encryption based, at least in part, on the password.
